(19) United States
(12) Patent Application Publication
(10) Pub. No.: US 2024/0177127 A1
(43) Pub. Date: May 30, 2024

(54) DIGITAL FINANCIAL MANAGEMENT OVER A COMMUNICATION NETWORK WITH CLIENT DEVICE ACCOUNT BALANCE PREVIEW WITHOUT USER AUTHENTICATION

(71) Applicant: Truist Bank, Charlotte, NC (US)

(72) Inventor: Bastien Buchaca, Raleigh, NC (US)

(21) Appl. No.: 18/060,297

(22) Filed: Nov. 30, 2022

(51) Int. Cl. G06Q 20/10; G06F 21/31

(52) U.S. Cl. CPC G06Q 20/108; G06F 21/31

(57) ABSTRACT

An apparatus, computing device, computer program product, and a computer-implemented method for delivering financial services and, more particularly, for facilitating enhanced network communication between a user and a financial institution. The computing device is operable to detect a client device executing a mobile application associated with a financial institution over a communication network. The computing device is then operable to cause, based on the detection and without user authentication, display of a GUI of an accounts balance preview dashboard for visual display on a user interface of the client device, the accounts balance preview dashboard visually displaying an account balance preview of one or more financial accounts at the financial institution.

### TECHNICAL FIELD

The present disclosure relates to an apparatus, computing device, computer program product, and computer-implemented method for delivering financial services and, more particularly, for facilitating enhanced network communication between a user and a financial institution in a manner that enables selectively preview of one or more user account balances by a client device without performing a user authentication process.

### BACKGROUND

Financial institutions that provide mobile financial services require that a user, upon launching a financial institution mobile application on a client device, under a user authentication process to gain entry and have access to one or more account balances at the financial institution. Completion of the authentication process generally requires that the user provide one or more user credentials (PIN, biometric data, etc.).

### SUMMARY

One or more embodiments of the present disclosure relate to a communication environment that facilitates enhanced communication between a financial institution and a client device over a communication network. Such enhanced communication is in support of user access and user management of one or more financial accounts at the financial institution.

In accordance with one or more embodiments set forth, illustrated, and described herein, upon a detection, by one or more financial institution servers associated with a financial institution, of a launching or execution of a mobile application associated with the financial institution (“financial institution mobile application”) by a client device of a user having one or more financial accounts at the financial institution, the user may enable selective preview of one or more account balances associated with the one or more financial accounts. The selective preview of account balances is accomplished without entering user authentication credentials or otherwise logging into the financial institution mobile application.

In accordance with one or more embodiments set forth, illustrated, and described herein, an apparatus comprises one or more of the following: one or more processors; and a non-transitory memory coupled to the one or more processors, the non-transitory memory including a set of instructions of computer-executable program code, which when executed by the one or more processors, cause the apparatus to: dynamically detect execution of a mobile application associated with a financial institution on a client device of a user having one or more financial accounts at the financial institution; and cause, based on the detection and without receipt of user authentication credentials, display of a first graphical user interface (GUI) that comprises an accounts balance preview dashboard having one or more tiles for visual display on a user interface of the client device which facilitate a selective preview of one or more account balances associated with the one or more financial accounts.

In accordance with the apparatus, the set of instructions, which when executed by the one or more processors, cause the apparatus to cause, temporally after the detection and temporally before the display of the accounts balance preview dashboard, display of a second GUI comprising a financial institution home dashboard on the user interface that includes a user-engageable icon prompting the user to selectively preview one or more account balances.

In accordance with the apparatus, the set of instructions, which when executed by the one or more processors, cause the apparatus to cause, in response to the user engaging the user-engageable icon, the display of the accounts balance preview dashboard on the user interface.

In accordance with the apparatus, the set of instructions, which when executed by the one or more processors, cause the apparatus to conduct user profile analysis of user profile data that is stored in the non-transitory memory to determine whether the account balance preview is enabled on the client device.

In accordance with the apparatus, the set of instructions, which when executed by the one or more processors, cause the apparatus to cause, based on the determination that the account balance preview is enabled on the client device, the display of the accounts balance preview dashboard on the user interface of the client device.

In accordance with the apparatus, the set of instructions, which when executed by the one or more processors, cause the apparatus to concurrently detect the client device and conduct the user profile analysis.

In accordance with the apparatus, the set of instructions, which when executed by the one or more processors, cause the apparatus to cause display of a third GUI comprising a user profile settings dashboard on the user interface to facilitate a selective enabling or disabling of the account balance preview.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to perform one or more of the following: dynamically detect execution of a mobile application associated with a financial institution on a client device of a user having one or more financial accounts at the financial institution; and cause, based on the detection, display of a first GUI comprising an accounts balance preview dashboard for visual display on a user interface of the client device to facilitate a selective preview of one or more account balances at the financial institution without receiving user authentication credentials.

In accordance with the computer program product, the set of instructions, which when executed by the one or more processors, cause the computing device to cause, temporally after the detection and temporally before the display of the accounts balance preview dashboard, display of a second GUI comprising a financial institution home dashboard on the user interface that includes a user-engageable icon prompting the user to selectively preview one or more account balances.

In accordance with the computer program product, the set of instructions, which when executed by the one or more processors, cause the computing device to cause, in response to the user engaging the user-engageable icon, the display of the accounts balance preview dashboard on the user interface.

In accordance with the computer program product, the set of instructions, which when executed by the one or more processors, cause the computing device to conduct user profile analysis of user profile data that is stored in non-transitory memory to determine whether the account balance preview is enabled on the client device.

In accordance with the computer program product, the set of instructions, which when executed by the one or more processors, cause the computing device to cause, cause, based on the determination that the account balance preview is enabled on the client device, the display of the accounts balance preview dashboard on the user interface.

In accordance with the computer program product, the set of instructions, which when executed by the one or more processors, cause the computing device to concurrently detect the client device and conduct the user profile analysis.

In accordance with the computer program product, the set of instructions, which when executed by the one or more processors, cause the computing device to cause display of a third GUI comprising a user profile settings dashboard on the user interface to facilitate a selective enabling or disabling of the account balance preview by the user.

In accordance with one or more embodiments set forth, illustrated, and described herein, a computer-implemented method comprises one or more of the following: dynamically detecting, by one or more financial institution servers associated with a financial institution, execution of a mobile application associated with the financial institution on a client device of a user having one or more financial accounts at the financial institution; and cause, by the one or more financial institution servers and based on the detection, display of a first GUI comprising an accounts balance preview dashboard on a user interface of the client device to facilitate a selective preview of one or more account balances at the financial institution without receiving user authentication credentials.

In accordance with the computer-implemented method, further comprising causing, by the one or more financial institution servers temporally after the detection and temporally before the display of an accounts balance preview dashboard, display of a second GUI comprising a financial institution home dashboard on the user interface that includes a user-engageable icon prompting the user to selectively preview one or more account balances.

In accordance with the computer-implemented method, further comprising causing, by the one or more financial institution servers in response to the user engaging the user-engageable icon, the display of the accounts balance preview dashboard on the user interface.

In accordance with the computer-implemented method, further comprising conducting, by the one or more financial institution servers, user profile analysis of user profile data that is stored in the non-transitory memory to determine whether the account balance preview is enabled on the client device.

In accordance with the computer-implemented method, further comprising, by the one or more financial institution servers, concurrently detecting the client device and conducting the user profile analysis.

In accordance with the computer-implemented method, further comprising, causing, by the one or more financial institution servers based on the determination that the account balance preview is enabled on the client device, the display of the accounts balance preview dashboard on the user interface.

In accordance with the computer-implemented method, further comprising, causing, by the one or more financial institution servers, display of a third GUI comprising a user profile settings dashboard on the user interface to facilitate a selective enabling or disabling of the account balance preview.

In accordance with one or more embodiments set forth, illustrated, and described herein, a computing device comprises one or more of the following: one or more processors; and a non-transitory memory coupled to the one or more processors, the non-transitory memory including a set of instructions of computer-executable program code, which when executed by the one or more processors, cause the computing device to: dynamically detect execution of a mobile application associated with a financial institution on a client device of a user having one or more financial accounts at the financial institution; and cause, based on the detection and without receipt of user authentication credentials, display of a first GUI comprising an accounts balance preview dashboard having one or more tiles for visual display on a user interface of the client device which facilitate a selective preview of one or more account balances associated with the one or more financial accounts.

In accordance with the computing device, the set of instructions, which when executed by the one or more processors, cause the computing device to cause, temporally after the detection and temporally before the display of the accounts balance preview dashboard, display of a second GUI comprising a financial institution home dashboard on the user interface that includes a user-engageable icon prompting the user to selectively preview one or more account balances.

In accordance with the computing device, the set of instructions, which when executed by the one or more processors, cause the computing device to cause, in response to the user engaging the user-engageable icon, the display of the accounts balance preview dashboard on the user interface.

In accordance with the computing device, the set of instructions, which when executed by the one or more processors, cause the computing device to conduct user profile analysis of user profile data that is stored in the non-transitory memory to determine whether the account balance preview is enabled on the client device.

In accordance with the computing device, the set of instructions, which when executed by the one or more processors, cause the computing device to cause, based on the determination that the account balance preview is enabled on the client device, the display of the accounts balance preview dashboard on the user interface of the client device.

In accordance with the computing device, the set of instructions, which when executed by the one or more processors, cause the computing device to concurrently detect the client device and conduct the user profile analysis.

In accordance with the computing device, the set of instructions, which when executed by the one or more processors, cause the computing device to cause display of a third GUI comprising a user profile settings dashboard on the user interface to facilitate a selective enabling or disabling of the account balance preview.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the client device of FIG. 1.

FIG. 3 illustrates a block diagram of the one or more financial institution servers of FIG. 1.

FIG. 4 illustrates a user interface of the client device of FIG. 1.

FIG. 5 illustrates a user profile registration dashboard for visual display on the user interface of FIG. 4.

FIGS. 6 and 7 respectively illustrate a user profile settings dashboard for visual display on the user interface of FIG. 4.

FIG. 8 illustrates a user account dashboard for visual display on the user interface of FIG. 4.

FIG. 9 illustrates a user profile settings dashboard for visual display on the user interface of FIG. 4.

FIG. 10 illustrates a user interface of the client device of FIG. 1 that includes a financial institution home dashboard, in accordance with one or more embodiments set forth and described herein.

FIG. 11 illustrates a balance preview dashboard having one or more tiles that visually display one or more user account balances without user authentication, in accordance with one or more embodiments set forth and described herein.

FIGS. 12 through 15 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to events or actions that can be caused, triggered, or otherwise occur without human intervention.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within a financial application.

A communication environment that facilitates enhanced user communication with a financial institution in support of user access and user management of one or more financial accounts at the financial institution. Upon the launching of a dashboard of financial institution on a client device, a user may transmit data related to the one or more financial accounts, and also receive data and information on one or more branch employees based on the geographic location of the user, or a user request or query for one or more financial services that are offered by the financial institution. Such data may be encrypted during communications between the client device and the one or more financial services.

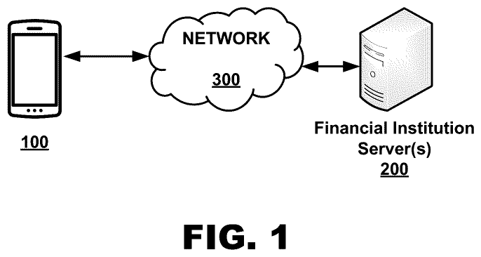

Turning to the figures, in which FIG. 1 illustrates a communication environment in which a user communicates with a financial institution over a communications network. A client device 100 operating in the communication environment facilitates user access to and user management of one or more financial accounts at one or more financial institution servers 200 of the financial institution. The communication environment includes the client device 100, the one or more financial institution servers 200, and a communications network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

In accordance with one or more embodiments set forth, described, and/or illustrated herein, each server in the one or more financial institution servers 200 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

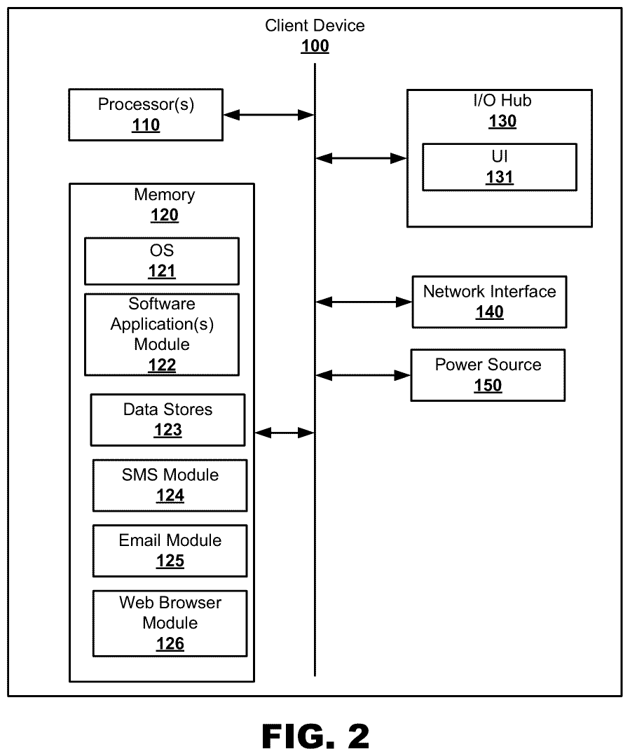

In the illustrated example embodiment of FIGS. 1 and 2, the client device 100 comprises a mobile device. Some of the possible operational elements of the client device 100 are illustrated in FIG. 2 and will now be described herein. It will be understood that it is not necessary for the client device 100 to have all the elements illustrated in FIG. 2. For example, the client device 100 may have any combination of the various elements illustrated in FIG. 2. Moreover, the client device 100 may have additional elements to those illustrated in FIG. 2.

The client device 100 includes one or more processors 110, a non-transitory memory 120 operatively coupled to the one or more processors 110, an I/O hub 130, a network interface 140, and a power source 150.

The memory 120 comprises a set of instructions of computer-executable program code. The set of instructions are executable by the one or more processors 110 to cause execution of an operating system 121 and one or more software applications of a software application module 122 that reside in the memory 120. The one or more software applications residing in the memory 120 includes, but is not limited to, a financial institution application that is associated with the financial institution. The financial institution application comprises a mobile application that facilitates establishment of a secure connection between the client device 100 and the one or more financial institution servers 200. The one or more processors 110 are operable to execute the mobile application to facilitate user access to the one or more financial accounts and user management of the one or more financial accounts.

The memory 120 also includes one or more data stores 123 that are operable to store one or more types of data. The client device 100 may include one or more interfaces that facilitate one or more systems or modules thereof to transform, manage, retrieve, modify, add, or delete, the data residing in the data stores 123. The one or more data stores 123 may comprise volatile and/or non-volatile memory. Examples of suitable data stores 123 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123 may be a component of the one or more processors 110, or alternatively, may be operatively connected to the one or more processors 110 for use thereby. As set forth, described, and/or illustrated herein, “operatively connected” may include direct or indirect connections, including connections without direct physical contact.

The memory 120 also includes an SMS module 124 operable to facilitate user transmission and receipt of text messages via the client device 100 though the network 300. In one example embodiment, a user may receive text messages from the financial institution that are associated with the user access and the user management of the one or more financial accounts. An email module 125 is operable to facilitate user transmission and receipt of email messages via the client device 100 through the network 300. In one example embodiment, a user may receive email messages from the financial institution that are associated with the user access and the user management of the one or more financial accounts. A user may utilize a web browser module 126 that is operable to facilitate user access to one or more websites associated with the financial institution through the network 300.

In accordance with one or more embodiments set forth, described, and/or illustrated herein, the client device 100 includes an I/O hub 130 operatively connected to other systems and subsystems of the client device 100. The I/O system 130 may include one or more of an input interface, an output interface, and a network controller to facilitate communications between the client device 100 and the server 200. The input interface and the output interface may be integrated as a single, unitary user interface 131, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110 to execute instructions. The input interface may comprise a user interface (UI), a graphical user interface (GUI), such as, for example, display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the client device 100 may serve as both a component of the input interface and a component of the output interface.

The client device 100 includes a network interface 140 operable to facilitate connection to the network 300. The client device 100 also includes power source 150 that comprises a wired powered source, a wireless power source, a replaceable battery source, or a rechargeable battery source.

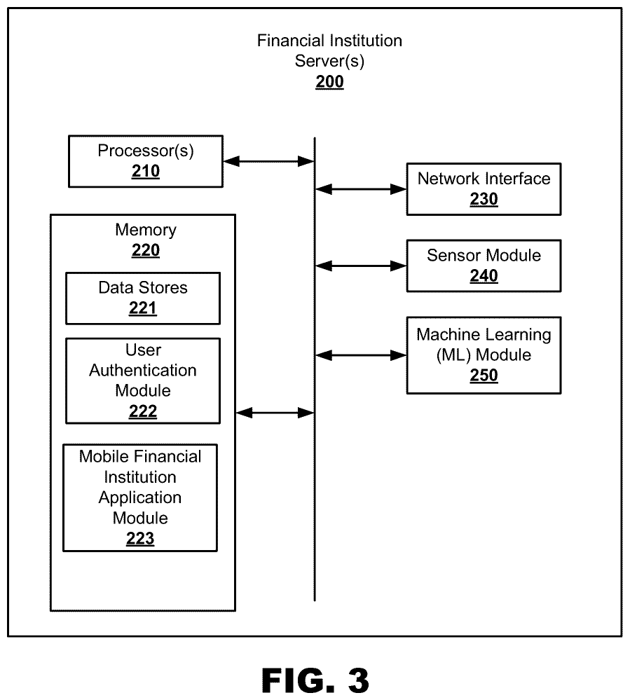

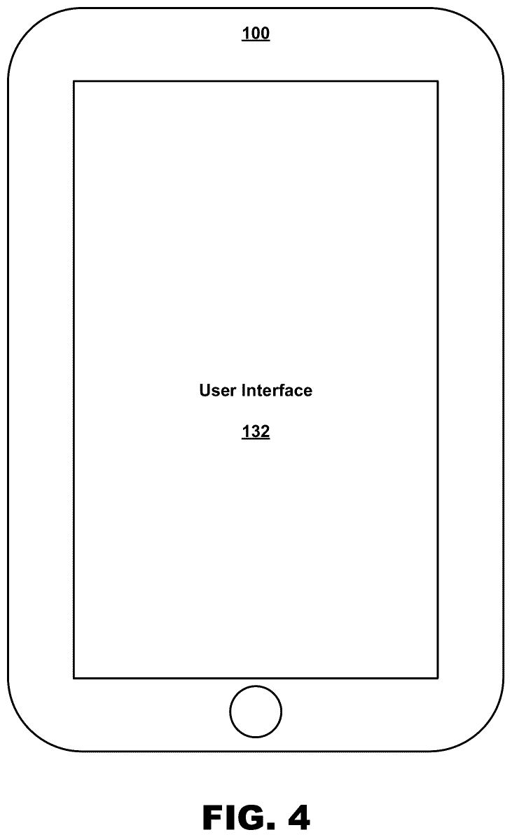

As illustrated in FIG. 3, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 3. For example, each server in the one or more financial institution servers 200 may have any combination of the various elements illustrated in FIG. 3. Moreover, each server in the one or more financial institution servers 200 may have additional elements to those illustrated in FIG. 3.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the server(s) to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 223 are operable to communicate with the client device 100 in a manner which facilitates user access to the one or more financial accounts in addition to user management of the one or more financial accounts based on successful user authentication. The data exchanged between the client device and the one or more financial services may be encrypted during communications therebetween.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and user management of the one or more financial accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, the client device 100 and the one or more financial institution server(s) 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine. Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

Any apparatus, computing device, computer program product, and computer-implemented method described herein may be at least partially processor-implemented, the one or more processors 210 being an example of hardware. For example, at least some of the operations of a method may be performed by one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

In accordance with one or more embodiments set forth, described, and/or illustrated herein, a user may, via the I/O hub 130 of the client device 100, launch or initialize execution of a financial institution mobile application over the communication network 300 for the purpose of registering a user profile. The user may already have one or more accounts with the financial institution, or otherwise seek to open one or more new accounts with the financial institution.

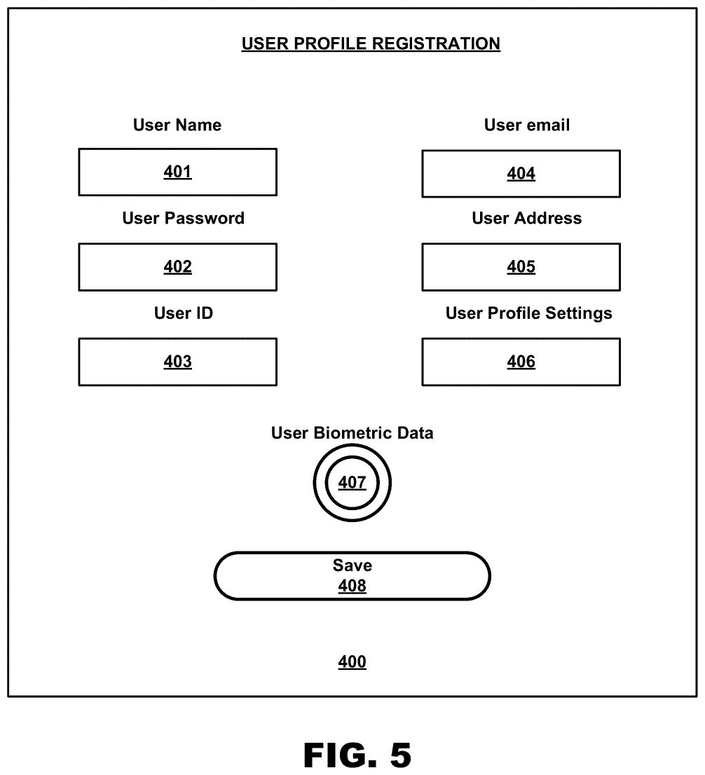

As illustrated in FIG. 5, the computer-executable program code may instruct the one or more processors 210 to cause (e.g., via the user authentication module 222) the display, generation, or rendering of a user profile registration dashboard 400 for visual display on a user interface 132 of the client device 100. The computer-executable program code may instruct the one or more processors 210 to cause the user authentication module 222 to generate or otherwise render a plurality of user input fields on the user profile registration dashboard 400 to be populated by the user to facilitate registration of a user profile and authentication credentials with the financial institution. The plurality of user input fields includes, but is not limited to, a username input field 401, a user password input field 402, a user identification (ID) input field 403, a user email input field 404, a user address input field 405, a user profile settings input field 406, and a user biometric data field 407 (facial, fingerprint, voice, ocular, etc.). This disclosure contemplates visual presentation of the plurality of user input fields in any relevant combination.

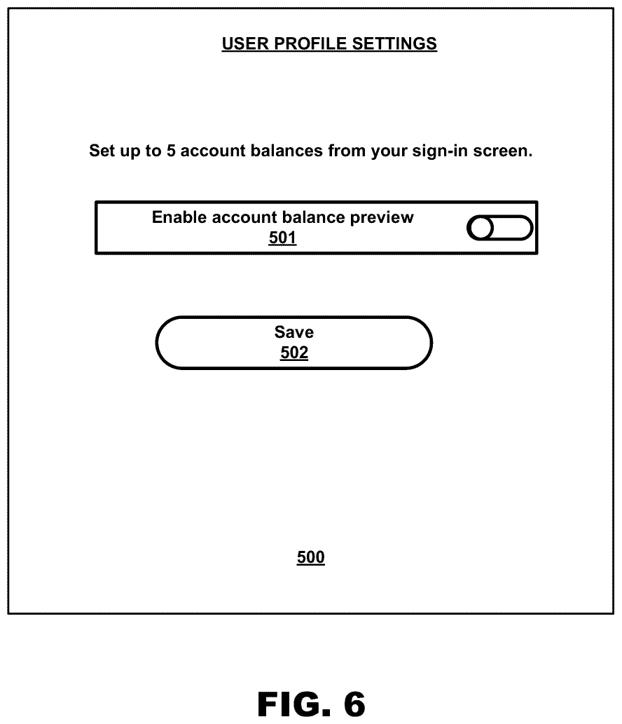

As illustrated in FIG. 6, the computer-executable program code may instruct the one or more processors 210 to cause (e.g., via the user authentication module 222) the display, generation, or rendering of a user profile settings dashboard 500 for visual display on the user interface 132 of the client device 100. The dashboard 500 may include a widget having a tile 501 with a user-engageable toggle switch to selectively enable or disable account balance preview by a user, and a user-engageable icon 502 to save the setting.

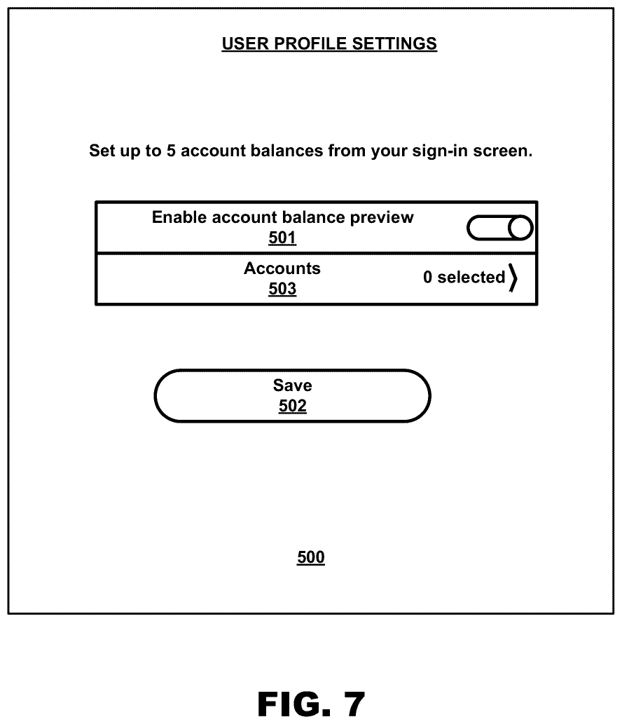

As illustrated in FIG. 7, responsive to the user selectively enabling the account balance preview, the computer-executable program code may instruct the one or more processors 210 to cause the display, generation, or rendering of a tile 503 having a user engageable arrowhead that allows the user to expand the list of financial accounts to enable or disable account balance preview without undergoing or otherwise bypassing the general user authentication protocols of the financial institution mobile application. In the illustrated embodiment, a threshold maximum limit of financial accounts that may be enabled for account balance preview without user authentication is five. This disclosure contemplates, however, the threshold maximum limit of financial accounts to be any number which optimizes or otherwise transforms the performance and functionality of the one or more embodiments in a manner that falls within the spirit and scope of the principles of this disclosure. The types of financial accounts subject to account balance preview without user authentication include, but is not limited to, any user account associated with a personal account, a commercial account, and a wealth management account. Example accounts may include, but is not limited to, checking accounts, savings accounts, credit accounts, money market accounts (MMA), certificates of deposit (CD), lines-of-credit, etc.

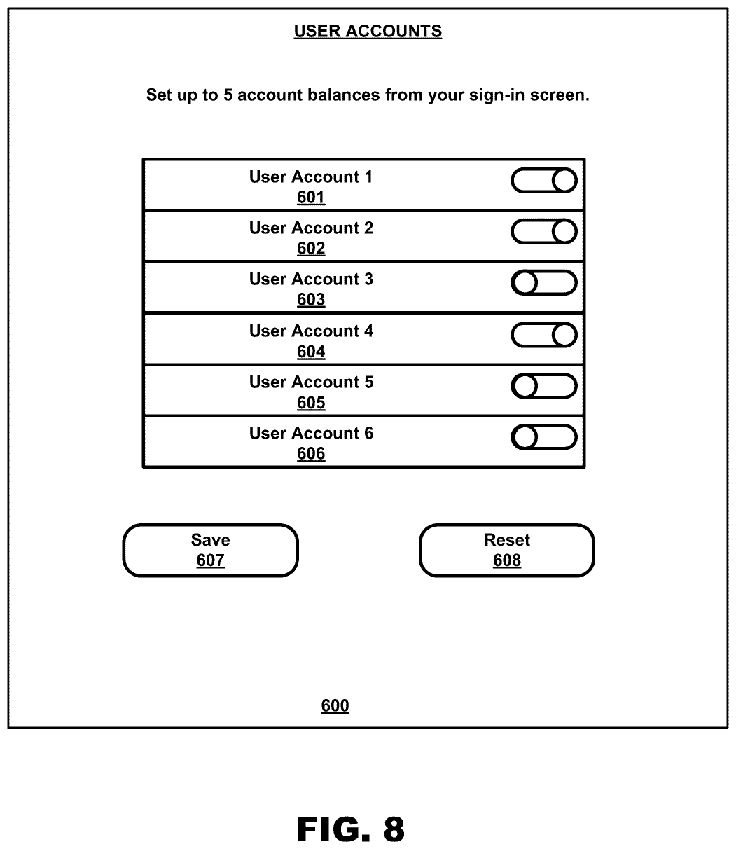

As illustrated in FIG. 8, responsive to the user selectively engaging the tile 502, the computer-executable program code may instruct the one or more processors 210 to cause the display, generation, or rendering of a financial accounts dashboard 600 for visual display on the user interface 132 of the client device 100. The financial accounts dashboard 600 may comprise a widget having a plurality of tiles 601-606 that visually displays the financial accounts at the financial institution. Each tile 601-606 includes a user-engageable toggle switch to permit a user to selectively enable or disable account one or more financial accounts (up to the threshold maximum amount) that will be subject to balance preview without undergoing or otherwise bypassing the general user authentication process for the financial institution mobile application. The financial accounts dashboard 600 also includes a user-engageable icon 602 to save the settings, and a user-engageable icon 603 to reset the settings.

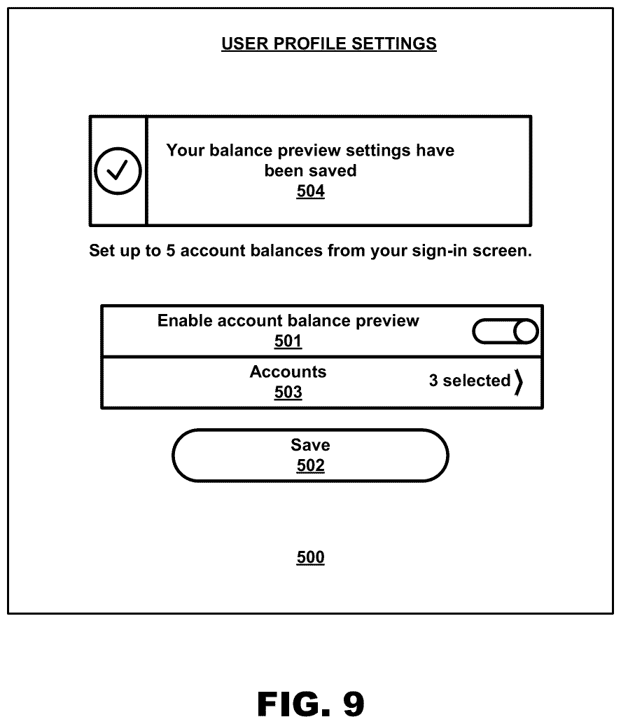

As illustrated in FIG. 9, responsive to the user enabling and saving the financial accounts intended to be subject to account balance preview, the computer-executable program code may instruct the one or more processors 210 to cause the display, generation, or rendering of the profile settings dashboard 500 for visual display on the user interface 132 of the client device 100, and includes a widget 504 that visually indicates or confirms that the account balance preview settings have been saved. The tile 503 has also been changed to visually indicate the overall number of financial accounts 601-606 that have been enabled to permit account balance preview.

In accordance with one or more embodiments set forth, described, and/or illustrated herein, the computer-executable program code may also instruct the one or more processors 210 to cause storage in the one or more data stores 221 the data, information, and authentication credentials in the user profile registration dashboard 400, the user profile settings dashboard 500, and the financial accounts dashboard 600.

In accordance with one or more embodiments set forth, described, and/or illustrated herein, the computer-executable program code may, subsequent to a user completing user profile registration, instruct the one or more processors 210 to cause the sensor module 240 to detect the financial institution mobile application running on or installed in the client device 100. Such detection may occur in instances where the financial institution mobile application running in the background of the client device 100. Such detection may be conducted based on a detection of metadata that includes one or more of: the electronic footprint of the financial institution mobile application, and the client device information (e.g., hardware type, OS, and client device name, etc.). This disclosure contemplates other forms of software detection that optimizes or otherwise transforms the performance and functionality of the one or more embodiments in a manner that falls within the spirit and scope of the principles of this disclosure.

In accordance with one or more embodiments set forth, described, and/or illustrated herein, the computer-executable program code may, responsive to the detection, instruct the one or more processors 210 to determine whether the account balance preview for display on the client device 100 is enabled by the user. This determination may occur based on analysis of the user profile data stored in the one or more data stores 221. This disclosure contemplates the detection of the financial institution mobile application running on or installed in the client device 100 and the determination of user-enablement of the account balance preview to be executed concurrently or otherwise in parallel to each other.

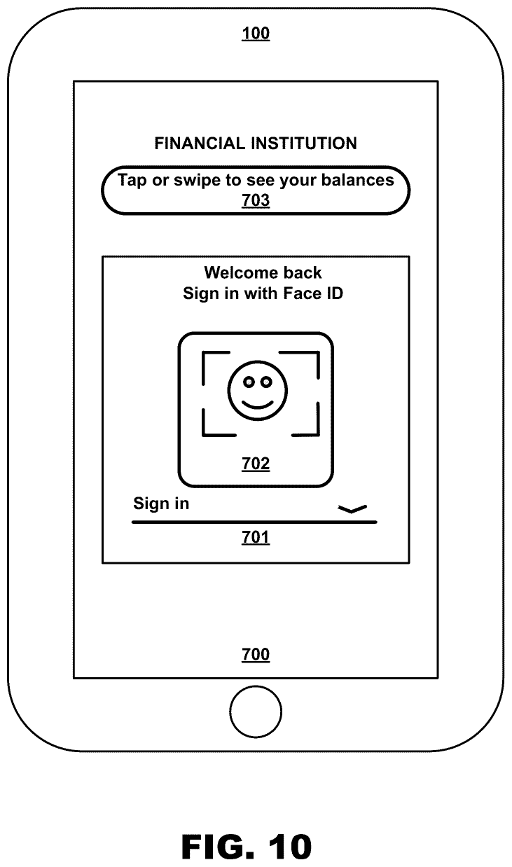

As illustrated in FIG. 10, the computer-executable program code may, responsive to the detection of the financial institution mobile application running on or installed in the client device 100 and the determination of user-enablement of the account balance preview, instruct the one or more processors 210 to cause, on a financial institution home dashboard 700 of the financial institution mobile application, the display, generation, or rendering of a widget for visual display on the user interface 132 of the client device 100. The widget includes a sign-in icon 701 that includes a user-engageable arrowhead that allows the user log into an existing user account, or create a new user account. The widget also includes a biometric data field 702 that permits a user to authenticate using biometric data.

In accordance with one or more embodiments set forth, described, and/or illustrated herein, the computer-executable program code may, responsive to the detection of the financial institution mobile application running on or installed in the client device 100 and the determination of user-enablement of the account balance preview, instruct the one or more processors 210 to cause, on the financial institution home dashboard 700, the generation or rendering of a user-engageable icon 703 for visual display on the user interface 132 of the client device 100.

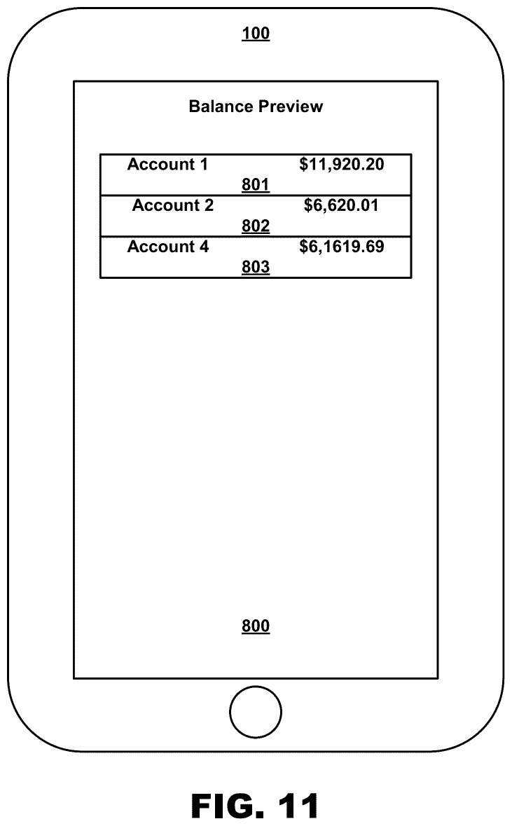

As illustrated in FIG. 11, the computer-executable program code may, responsive to user engagement of the icon 703, instruct the one or more processors 210 to cause, on the financial institution home dashboard 700, the display, generation, or rendering of a balance preview dashboard 800 for visual display on the user interface 132 of the client device 100. The balance preview dashboard 800 may comprise a widget having one or more tiles 801, 802, 803 that visually displays a balance preview of the enabled financial accounts without undergoing or otherwise bypassing the general user authentication protocols of the financial institution mobile application. Accordingly, a user, having previously enabled account preview on the client device 100, may preview one or account balances at the financial institution without providing user profile credentials or user authentication credentials.

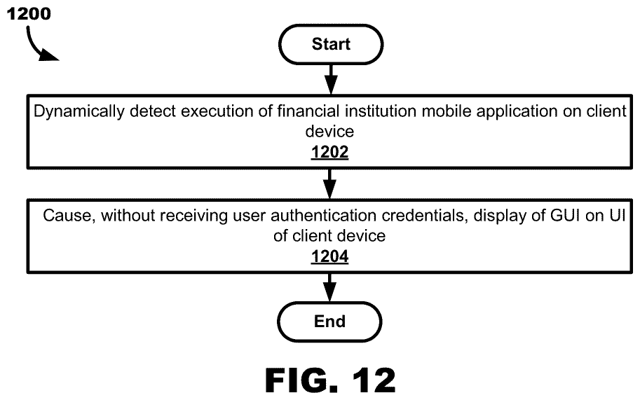

Illustrated examples shown in FIGS. 12 to 15 set forth computer-implemented methods 1200, 1300, 1400, and 1500. In one or more examples, the respective flowcharts of the computer-implemented methods 1200, 1300, 1400, and 1500 may be implemented by the one or more processors 210 of the one or more financial institution servers 200. In particular, the computer-implemented methods 1200, 1300, 1400, and 1500 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 1200, 1300, 1400, and 1500 set forth, described, and/or illustrated herein, or provides functionality set forth, described, and/or illustrated.

As illustrated in FIG. 12, illustrated process block 1202 includes dynamically detecting, by one or more financial institution servers associated with a financial institution, execution of a mobile application associated with the financial institution on a mobile device of a user having one or more financial accounts at the financial institution. The computer-implemented method 1200 may then proceed to illustrated process block 1204, which includes causing, by one or more financial institution servers associated with a financial institution based on the detection and without receipt of user authentication credentials, display of a first GUI comprising an accounts balance preview dashboard having one or more tiles for visual display on a user interface of the client device which facilitate a selective preview of one or more account balances associated with the one or more financial accounts.

The computer-implemented method 1200 may terminate or end after execution of process block 1204.

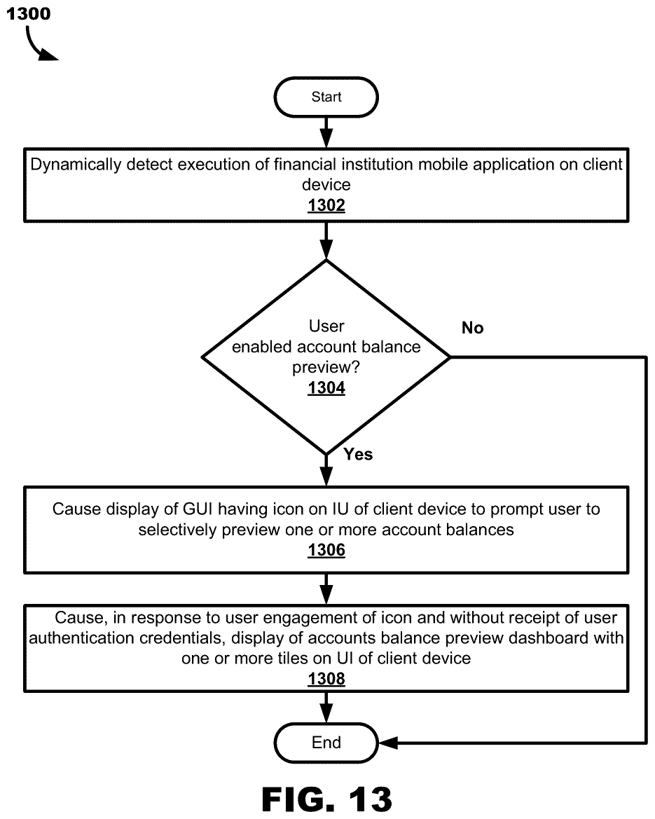

As illustrated in FIG. 13, illustrated process block 1302 includes dynamically detecting, by one or more financial institution servers associated with a financial institution, execution of a mobile application associated with the financial institution on a client device of a user having one or more financial accounts at the financial institution.

The computer-implemented method 1300 may then proceed to illustrated process block 1304, which includes determining, by the one or more financial institution servers, whether the user has enabled account balance preview without user authentication.

If “No,” i.e., should the one or more financial institution servers determine that the user has not enabled account balance preview without user authentication, the computer-implemented method 1300 then may terminate or end.

If “Yes,” i.e., should the one or more financial institution servers determine that the user has not enabled account balance preview without user authentication, the computer-implemented method 1300 then proceeds to process block 1306, which includes causing, by the one or more financial institution servers, display of a second GUI comprising a financial institution home dashboard that includes a user-engageable icon prompting the user to selectively preview one or more account balances.

The computer-implemented method 1300 may then proceed to illustrated process block 1308, which includes causing, by the one or more financial institution servers in response to the user engaging the user-engageable icon, display of the accounts balance preview dashboard.

The method 1300 may terminate or end after execution of process block 1308.

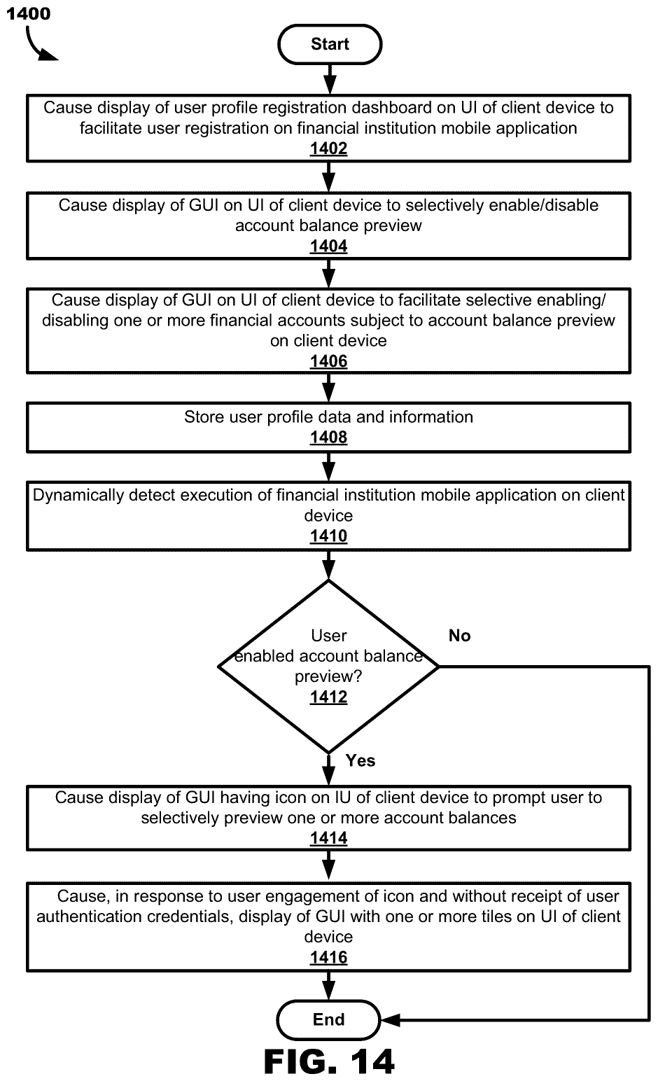

As illustrated in FIG. 14, illustrated process block 1402 includes causing, by one or more financial institution servers associated with a financial institution, display of a first GUI comprising a user profile registration dashboard of a mobile application associated with the financial institution on a user interface of a client device of a user having one or more financial accounts at the financial institution.

In accordance with the example illustrated process block 1402, display of the user profile registration dashboard facilitates user registration on the mobile application associated with the financial institution on the client device.

The computer-implemented method 1400 may then proceed to illustrated process block 1404, which includes causing, by the one or more financial institution servers, display of a second GUI comprising a financial accounts dashboard of the mobile application on the user interface.

In accordance with the example illustrated process block 1404, display of the financial accounts dashboard facilitates the selective enabling/disabling by the user of the account balance preview on the client device.

The computer-implemented method 1400 may then proceed to illustrated process block 1406, which includes causing, by the one or more financial institution servers, display of a third GUI comprising a user profile settings dashboard of the mobile application on the user interface.

In accordance with the example illustrated process block 1406, display of the user profile settings dashboard facilitates the selective enabling/disabling by the user of the one or more financial accounts that will be subject to account balance preview on the client device.

The computer-implemented method 1400 may then proceed to illustrated process block 1408, which includes storing, by the one or more financial institution servers, user profile data and information in memory.

The computer-implemented method 1400 may then proceed to illustrated process block 1410, which includes dynamically detecting, by the one or more financial institution servers temporally after storing the user profile data and information in memory, execution of the mobile application on the client device.

The computer-implemented method 1400 may then proceed to illustrated process block 1412, which includes determining, by the one or more financial institution servers based on the stored user profile data and information, whether the user has enabled account balance preview without user authentication.

If “No,” i.e., should the one or more financial institution servers determine that the user has not enabled account balance preview without user authentication, the computer-implemented method 1400 then may terminate or end.

If “Yes,” i.e., should the one or more financial institution servers determine that the user has not enabled account balance preview without user authentication, the computer-implemented method 1400 then proceeds to process block 1414, which includes causing, by the one or more financial institution servers, display of the second GUI that includes a user-engageable icon prompting the user to selectively preview one or more account balances.

The computer-implemented method 1400 may then proceed to illustrated process block 1416, which includes causing, by the one or more financial institution servers in response to the user engaging the user-engageable icon, display of a fourth GUI comprising an accounts balance preview dashboard of the mobile application that selective preview one or more account balances at the financial institution.

In accordance with the example illustrated process block 1416, display of the accounts balance preview dashboard is performed without receiving user authentication credentials.

The method 1400 may terminate or end after execution of process block 1416.

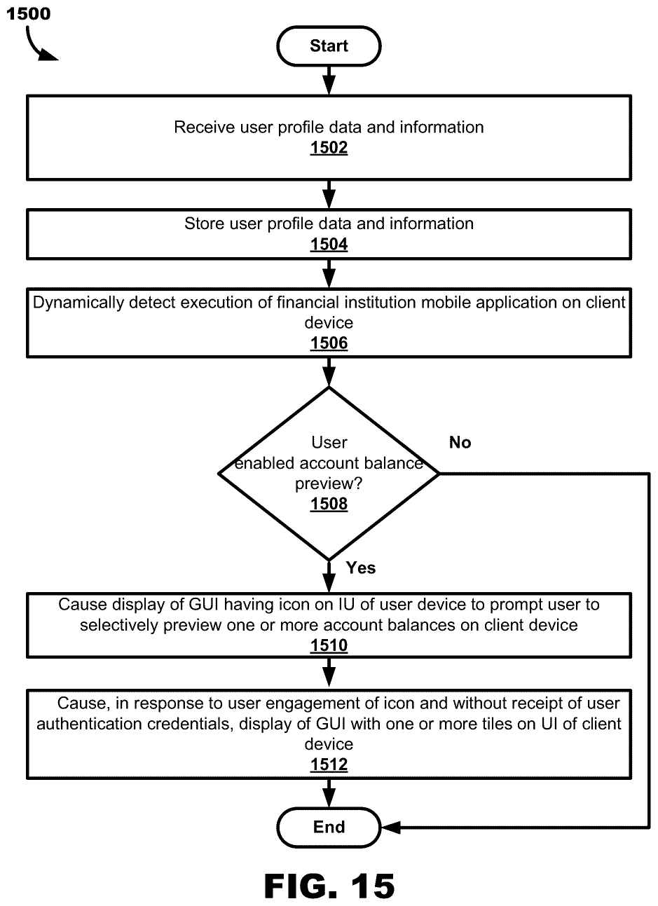

As illustrated in FIG. 15, illustrated process block 1502 includes receiving, by one or more financial institution servers associated with a financial institution via a mobile application with the financial institution, user profile data and information from a client device of a user having one or more financial accounts at the financial institution.

The computer-implemented method 1500 may then proceed to illustrated process block 1504, which includes storing, by the one or more financial institution servers, the user profile data and information in memory.

The computer-implemented method 1500 may then proceed to illustrated process block 1506, which includes dynamically detecting, by the one or more financial institution servers temporally after storing the user profile data and information in memory, execution of the mobile application on the client device.

The computer-implemented method 1500 may then proceed to illustrated process block 1508, which includes determining, by the one or more financial institution servers based on the stored user profile data and information, whether the user has enabled account balance preview without user authentication.

If “No,” i.e., should the one or more financial institution servers determine that the user has not enabled account balance preview without user authentication, the computer-implemented method 1500 then may terminate or end.

If “Yes,” i.e., should the one or more financial institution servers determine that the user has not enabled account balance preview without user authentication, the computer-implemented method 1500 then proceeds to process block 1510, which includes causing, by the one or more financial institution servers, display of a first GUI comprising a financial institution home dashboard of the mobile application that includes a user-engageable icon prompting the user to selectively preview one or more account balances.

The computer-implemented method 1500 may then proceed to illustrated process block 1512, which includes causing, by the one or more financial institution servers in response to the user engaging the user-engageable icon, display of a second GUI comprising an accounts balance preview dashboard of the mobile application that selective preview one or more account balances at the financial institution.

In accordance with the example illustrated process block 1512, display of the accounts balance preview dashboard is performed without receiving user authentication credentials.

The method 1500 may terminate or end after execution of process block 1512.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, cause the apparatus to:
dynamically detect execution of a mobile application associated with a financial institution on a client device of a user having one or more financial accounts at the financial institution; and
cause, based on the detection and without receipt of user authentication credentials, display of a first graphical user interface (GUI) having one or more tiles for visual display on a user interface of the client device which facilitate a selective preview of one or more account balances associated with the one or more financial accounts.

2. The apparatus of claim 1, wherein the set of instructions, which when executed by the one or more processors, cause the apparatus to cause, temporally after the detection and temporally before the display of the first GUI, display of a second GUI on the user interface that includes a user-engageable icon prompting the user to selectively preview one or more account balances.

3. The apparatus of claim 2, wherein the set of instructions, which when executed by the one or more processors, cause the apparatus to cause, in response to the user engaging the user-engageable icon, the display of the first GUI on the user interface.

4. The apparatus of claim 1, wherein the set of instructions, which when executed by the one or more processors, cause the apparatus to conduct user profile analysis of user profile data that is stored in the non-transitory memory to determine whether the account balance preview is enabled on the client device.

5. The apparatus of claim 4, wherein the set of instructions, which when executed by the one or more processors, cause the apparatus to cause, based on the determination that the account balance preview is enabled on the client device, the display of the first GUI on the user interface of the client device.

6. The apparatus of claim 4, wherein the set of instructions, which when executed by the one or more processors, cause the apparatus to concurrently detect the client device and conduct the user profile analysis.

7. The apparatus of claim 1, wherein the set of instructions, which when executed by the one or more processors, cause the apparatus to cause display of a third GUI on the user interface of the client device to facilitate a selective enabling or disabling of the account balance preview.

8. A computer program product comprising at least one non-transitory computer readable medium having with a set of instructions of computer-executable program code, which when executed by one or more processors of a computing device, cause the computing device to:
dynamically detect execution of a mobile application associated with a financial institution on a client device of a user having one or more financial accounts at the financial institution; and
cause, based on the detection, display of a first graphical user interface (GUI) for visual display on a user interface of the client device to facilitate a selective preview of one or more account balances at the financial institution without receiving user authentication credentials.

9. The computer program product of claim 8, wherein the set of instructions, which when executed by the one or more processors, cause the computing device to cause, temporally after the detection and temporally before the display of the first GUI, display of a second GUI on the user interface that includes a user-engageable icon prompting the user to selectively preview one or more account balances.

10. The computer program product of claim 9, wherein the set of instructions, which when executed by the one or more processors, cause the computing device to cause, in response to the user engaging the user-engageable icon, the display of the first GUI on the user interface.

11. The computer program product of claim 8, wherein the set of instructions, which when executed by the one or more processors, cause the computing device to conduct user profile analysis of user profile data that is stored in the non-transitory memory to determine whether the account balance preview is enabled on the client device.

12. The computer program product of claim 11, wherein the set of instructions, which when executed by the one or more processors, cause the computing device to cause, based on the determination that the account balance preview is enabled on the client device, the display of the first GUI on the user interface.

13. The computer program product of claim 11, wherein the set of instructions, which when executed by the one or more processors, cause the computing device to concurrently detect the client device and conduct the user profile analysis.

14. The computer program product of claim 8, wherein the set of instructions, which when executed by the one or more processors, cause the computing device to cause display of a third GUI on the user interface to facilitate a selective enabling or disabling of the account balance preview.

15. A computer-implemented method, comprising:
dynamically detecting, by one or more financial institution servers associated with a financial institution, execution of a mobile application associated with the financial institution on a client device of a user having one or more financial accounts at the financial institution; and
cause, by the one or more financial institution servers and based on the detection, display of a first graphical user interface (GUI) on a user interface of the client device to facilitate a selective preview of one or more account balances at the financial institution without receiving user authentication credentials.

16. The computer-implemented method of claim 15, further comprising causing, by the one or more financial institution servers temporally after the detection and temporally before the display of the first GUI, display of a second GUI on the user interface that includes a user-engageable icon prompting the user to selectively preview one or more account balances.

17. The computer-implemented method of claim 16, further comprising causing, by the one or more financial institution servers in response to the user engaging the user-engageable icon, the display of the first GUI on the user interface.

18. The computer-implemented method of claim 15, further comprising conducting, by the one or more financial institution servers, user profile analysis of user profile data that is stored in non-transitory memory to determine whether the account balance preview is enabled on the client device.

19. The computer-implemented method of claim 18, further comprising, causing, by the one or more financial institution servers based on the determination that the account balance preview is enabled on the client device, the display of the first GUI on the user interface.

20. The computer-implemented method of claim 15, further comprising, causing, by the one or more financial institution servers, display of a third GUI on the user interface to facilitate a selective enabling or disabling of the account balance preview.
